(19) United States
(12) Patent Application Publication
(10) Pub. No.: US 2022/0379826 A1
(43) Pub. Date: Dec. 1, 2022

(54) SAFETY METHOD AND SYSTEM ON VEHICLES WITH TRANSPORT REFRIGERATION

(71) Applicant: Carrier Corporation, Palm Beach Gardens, FL (US)

(72) Inventors: Suzankumar Gongate, Hyderabad, Telangana (IN); Shantan Kumar Renikuntla, Hyderabad, Telangana (IN); Chandra Shekhar Pullela, Hyderabad, Telangana (IN); Rajesh Kumar Sirigineedi, Hyderabad, Telangana (IN); Devanatha Reddy Sareddy, Hyderabad, Telangana (IN)

(21) Appl. No.: 17/770,471

(22) PCT Filed: Sep. 29, 2020
(86) PCT No.: PCT/IB2020/059080

§ 371 Date: Apr. 20, 2022

(30) Foreign Application Priority Data
Oct. 21, 2019 (IN) 201911042622

(51) Int. Cl. B60R 16/023; B60R 16/03; B60W 10/30; B60W 50/12; B60L 1/00

(52) U.S. Cl. CPC B60R 16/0231; B60R 16/03; B60W 10/30; B60W 50/12; B60L 1/003

(57) ABSTRACT

Aspects of the invention are directed towards a system and method for safe decoupling of the external power supply from a vehicle. The technology described herein provides an indication or an alert to the user at an appropriate time and avoids the possible damage to the system. The system comprises an electrical port by which the refrigerator can be connected to an external AC mains supply via an electrical cable when the vehicle is in stationary state. The system further comprises a refrigerator main controller unit (RMU) for controlling the power delivered to the refrigerator in both stationary and driving states of the vehicle. There is a safety system installed for restricting the vehicle from being driven when the electrical port of the system is connected to the AC mains supply via the electrical cable and the refrigerator is powered by the AC mains supply.

### TECHNICAL FIELD OF INVENTION

The present invention generally relates to control systems. More particularly, the invention relates to a system and a method for notifying a user of electrical connection with the system.

### BACKGROUND OF THE INVENTION

There are various items which require suitable environment for transportation. In the industry specific transportation system, various measures are employed for controlling various parameters such as temperature, humidity and carbon dioxide. A transportation system with a mechanism to control parameters in this way is commonly called “reefer.”

The items which need critical care with respect to the environment are transported in different kinds of control units. For example, transport refrigeration units are used to carry items which are required to be maintained in a specific and critical range of temperature and other parameters such as gas pressure and the like.

The transport refrigeration system may be available in various transport means such as air, water, or road transport. The transport refrigeration systems are powered by batteries or by a diesel generator when the vehicle carrying the transport refrigeration system is in motion. When the vehicle is docked or in stationary position for loading or unloading of items, the transport refrigeration unit is generally supplied power from an external AC power supply. The external power supply needs to be disconnected when the vehicle starts moving again. The connection of the external power supply, as vehicle moves may cause physical damage to the transport refrigeration unit and the external power supply. Also, the force against the motion during connection of the external power supply with the transport refrigeration unit may create a spark which may also lead to fire and other damages.

In view of the afore-mentioned problems, there is a need of an effective system and a method of providing an alert to the user such as a driver such that the vehicle does not start moving if the external power supply is connected with the transport refrigeration system inside the vehicle. There is a need to avoid damage to the transport refrigeration unit and avoid fire.

### SUMMARY OF THE INVENTION

Various embodiments of the invention describe a system comprising a refrigerator installed on a vehicle. A battery or diesel generator powers the refrigerator when the vehicle is in a driving state. There is an electrical port available on the system for connecting to an AC mains supply via an electrical cable to power the refrigerator when the vehicle is in a stationary state. A refrigerator main controller unit (RMU) controls the power delivered to the refrigerator in both stationary and driving states of the vehicle. Further, the system comprises a safety system restricting the vehicle from being driven when the electrical port is connected to the electrical cable and the refrigerator is powered by the AC mains supply.

In an embodiment of the invention, the safety system comprises an ignition relay switchable between a “closed” and an “open” state. The ignition relay connects an ignition switch of the vehicle to the electronic control unit (ECU) of the vehicle in the ‘closed’ state and disconnects the ignition switch from the ECU in the ‘open’ state. The ignition switch of the vehicle is switchable to an “on” state to allow the ECU to drive the vehicle and an “off” state to restrict the ECU from driving the vehicle.

In yet another embodiment of the invention, the RMU detects whether the electrical port is connected to the electrical cable and the refrigerator is powered by the AC mains supply and detects whether the ignition switch of the vehicle is in the “on” state or in the “off” state. The RMU switches the ignition relay between the “open” and “closed” states based on the detections.

In another embodiment of the invention, the RMU switches the ignition relay to the “open” state when the ignition switch is in the “on” state and the refrigerator is powered by the AC mains supply.

In another embodiment of the invention, the RMU switches the ignition relay to the “closed” state when the ignition switch is in the “off” state and the refrigerator is powered by the AC mains supply.

In yet another embodiment of the invention, the RMU switches the ignition relay to the “closed” state when the ignition switch is in the “on” state and the refrigerator is powered by the battery or diesel generator.

In another embodiment of the invention, the RMU switches the ignition relay to the “closed” state when the ignition switch is in the “off” state and the refrigerator is powered by the battery or diesel generator.

In a different embodiment of the invention, the safety system comprises a buzzer and the RMU activates the buzzer to alert a driver when the refrigerator is powered directly from the AC Mains supply and the ignition switch is in the “on” state.

In another embodiment of the invention a method for safe decoupling of the AC mains supply is disclosed. The method comprises powering a refrigerator installed on a vehicle by a battery or diesel generator when the vehicle is in a driving state. The method further comprises connecting the refrigerator to an AC mains supply via an electrical cable to directly power the refrigerator when the vehicle is in a stationary state. The power delivered to the refrigerator in both stationary and driving states of the vehicle is controlled by a refrigerator main controller unit (RMU). The vehicle is restricted from being driven by a safety system when the electrical port is connected to the electrical cable and the refrigerator is powered directly from the AC mains supply.

In another embodiment of the invention, the safety system comprises an ignition relay switchable between a “closed” and an “open” state, wherein the ignition relay connects the ignition switch to the ECU in the ‘closed’ state and disconnects the ignition switch from the ECU in the ‘open’ state.

In still another embodiment of the invention, the RMU detects if electrical port is connected to the electrical cable and the refrigerator is powered directly from the AC mains supply and detects if ignition switch of the vehicle is in the “on” or in the “off” states. The RMU switches the ignition relay between the “open” and “closed” states based on the detections.

In another embodiment of the invention, the RMU switches the ignition relay to the “open” state when the ignition switch is in the “on” state and the refrigerator is powered directly from the AC Mains supply.

In still another embodiment of the invention, the RMU switches the ignition relay to the “closed” state when the ignition switch is in the “off” state and the refrigerator is powered directly from the AC Mains supply.

In yet another embodiment of the invention, the RMU switches the ignition relay to the “closed” state when the ignition switch is in the “on” state and the refrigerator is powered by the battery.

In another embodiment of the invention, the safety system comprises a buzzer, wherein RMU activates the buzzer to alert a driver when the refrigerator is powered directly from the AC Mains supply and the ignition switch is in the “on” state.

In yet another embodiment of the invention, the vehicle is a battery electric vehicle and the battery that powers the refrigerator system when the vehicle is in a driving state is the same battery that powers the prime mover of the vehicle.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is an exemplary block diagram illustrating different components of a system according to an exemplary embodiment of the invention.

FIG. 2 is an exemplary diagram illustrating the different components of the system on a vehicle.

FIG. 3 is an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with a system and a method for safe decoupling of the external power supply from a vehicle. The technology described herein provides an indication or an alert to the user at an appropriate time and avoids the possible damage to the system. The system determines various conditions and accordingly identifies whether to start the vehicle or not.

Various embodiments of the invention describe a system comprising a refrigerator installed on a vehicle. The system includes a battery or diesel generator for powering the refrigerator when the vehicle is in driving state. The battery may also be used to power the vehicle if the vehicle is battery operated. The system comprises an electrical port by which the refrigerator can be connected to an external AC mains supply via an electrical cable when the vehicle is in stationary state. The system further comprises a refrigerator main controller unit (RMU) for controlling the power delivered to the refrigerator in both stationary and driving states of the vehicle. There is a safety system installed for restricting the vehicle from being driven when the electrical port of the system is connected to the AC mains supply via the electrical cable and the refrigerator is powered by the AC mains supply.

In an embodiment of the system, the system is installed on a vehicle. The vehicle may be an electric vehicle being powered by electricity. The vehicle may be fuel driven, electric vehicle, or a battery operated vehicle. Different types of vehicles may be used with the system and are within the scope of the invention.

In an embodiment of the invention, the system comprises battery. The battery may be a Li-ion battery, AL-Air battery, Lead-acid battery or the like. Moreover, the battery may be used to power the refrigerator installed on the vehicle. Also, the same battery may be used for powering the vehicle.

As described herein, the refrigerator may be any control system used to control different environmental parameters, such as a temperature, humidity, different gases and the like. The refrigerator may be a control system capable of being installed on the vehicle. The refrigerator may be powered by a battery or diesel generator or may be operated using an external power source such as external AC supply.

In an embodiment of the invention, refrigerator main control unit (RMU) is used to control the power delivered to the refrigerator when the vehicle is in motion as well as stationary position. The RMU detects the environmental parameters inside the refrigerator for one or more items and accordingly maintains the parameters by controlling the power supplied to the refrigerator.

In an embodiment of the invention, an automotive electronic control unit or electronic control unit (ECU) is installed on the vehicle for controlling the operations of the vehicle. The ECU controls the ignition of the vehicle, speed, fuel, battery and the like to appropriately control the operation of the vehicle.

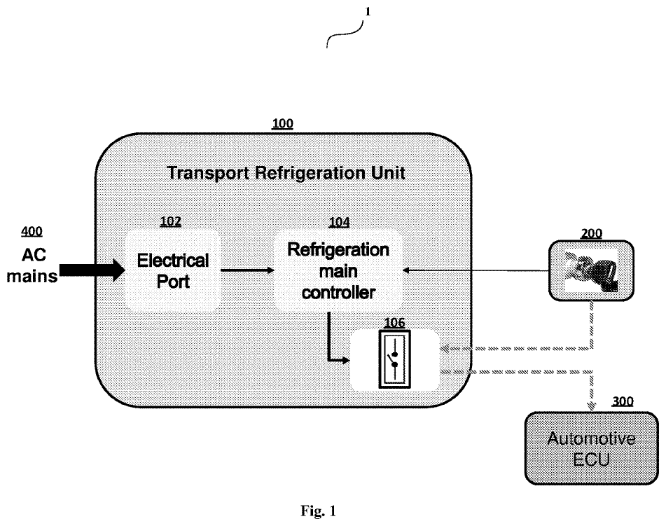

FIG. 1 depicts a system 1 for alerting a user if an external power supply such as AC mains supply is connected to the vehicle. The system 1 depicts a transport refrigeration unit 100 which is coupled with an ignition switch 200 of the vehicle. An automotive electronic control unit 300 is coupled with the transport refrigeration unit 100 for providing control signals for operating the vehicle. The automotive electronic control unit 300 allows the vehicle to be driven based on the state of an ignition relay 106 of the transport refrigeration unit 100. The transport refrigeration unit 100 comprises an electrical box or an electrical port 102 which couples a refrigeration main controller 104 of the transport refrigeration unit 100 with the AC mains supply 400 which is external to the vehicle. The transport refrigeration unit 100 may be coupled with a battery (not shown) or diesel generator (not shown). The battery or diesel generator is used to power the refrigeration unit installed on the vehicle.

The ignition relay 106 may be part of a safety system of the transport refrigeration unit 100. When the vehicle is in motion, the battery or diesel generator is used to power the transport refrigeration unit 100 installed on the vehicle. The transport refrigeration unit 100 or the refrigerator provides an appropriate environment to control environmental parameters for items placed inside the refrigerator 100. But when the vehicle is stopped for one or more reasons. For instance, the vehicle may be stopped to load and/or unload the items from the refrigerator 100. The vehicle may also be stopped to refresh or charge the battery of the vehicle during long distance transportation. When the vehicle is stopped, generally, the battery supplying the power to the refrigerator is disconnected and the AC mains supply external to the vehicles is provided to power the refrigerator during stop time. Moreover, the AC mains supply 400 is used to charge the battery for further use.

In an embodiment of the invention, the system 1 comprises a safety system to alert a user or driver of the vehicle not to start or provide ignition to the vehicle when the AC mains supply 400 is connected to the vehicle. The safety system comprises an ignition relay 106 which is switchable between a “closed state” and an “open state.” The ignition relay 106 is connected to the automotive electronic control unit (ECU) 300 to provide the signals whether to start the vehicle or not. Accordingly, the automotive electronic control unit 300 prevents the vehicle from being driven when the external power supply is connected to the vehicle.

The refrigeration main controller unit (RMU) 104 detects whether the refrigerator is connected to the AC mains supply 400 and whether the ignition switch 200 of the vehicle is “ON”. On determining that the AC mains supply is connected to the vehicle and the ignition switch is “ON”, the RMU switches the ignition relay to “open state.” On detecting the “open state” of the ignition relay 106, the automotive electronic control unit 300 or RMU 104 alerts the driver by activating a buzzer on the vehicle indicating not to drive the vehicle. In an embodiment of the invention, other alerting means such as a LED display, a notification on a user device, a beep sound device may be activated by the automotive ECU 300 or RMU 104. Thus, the present invention provides an alert to a user if the external power supply is connected to the vehicle. The alert also provides any physical damage to the transport refrigeration unit as well the electric power supply.

When the vehicle suddenly starts moving with the external power supply connected, there may be a spark which may lead to fire on the vehicle as well as adjoining premises and to the external power supply. The alert provided by the automotive ECU 300 or RMU 104 may avoid such spark and the fire.

In an embodiment of the invention, the RMU 104 may switch the ignition relay 106 to “closed state” when the ignition switch 200 is “OFF” and the refrigerator 100 is powered by the AC mains supply 400.

In an embodiment of the invention, the RMU 104 may switch the ignition relay 106 to “closed state” when the ignition switch 200 is “ON” and the refrigerator 100 is powered by the battery or diesel generator.

In an embodiment of the invention, RMU 104 switches the ignition relay 106 to the “closed state” when the ignition switch 200 is in “OFF” and the refrigerator 100 is powered by the battery or diesel generator.

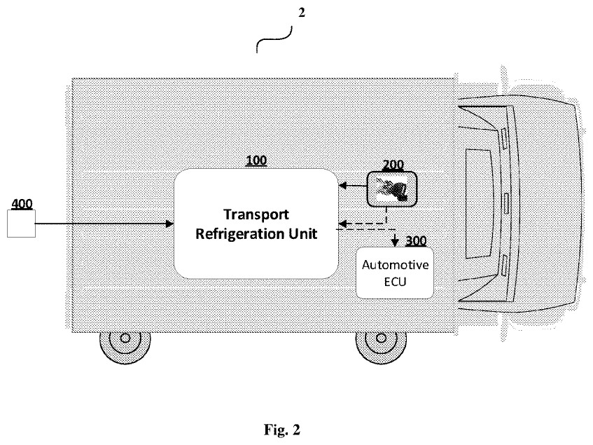

FIG. 2 depicts an embodiment of the invention with details of the system 1 on the vehicle 2. It can be seen that the transport refrigeration unit 100 is installed on the vehicle and is coupled with the ignition switch 200 and the automotive ECU 300. The components of the transport refrigeration unit 100 or refrigerator are same as explained in FIG. 1. The transport refrigeration unit 100 is connected to the AC mains supply 400 external to the vehicle. The operation of the system along with the components are similar to as described above.

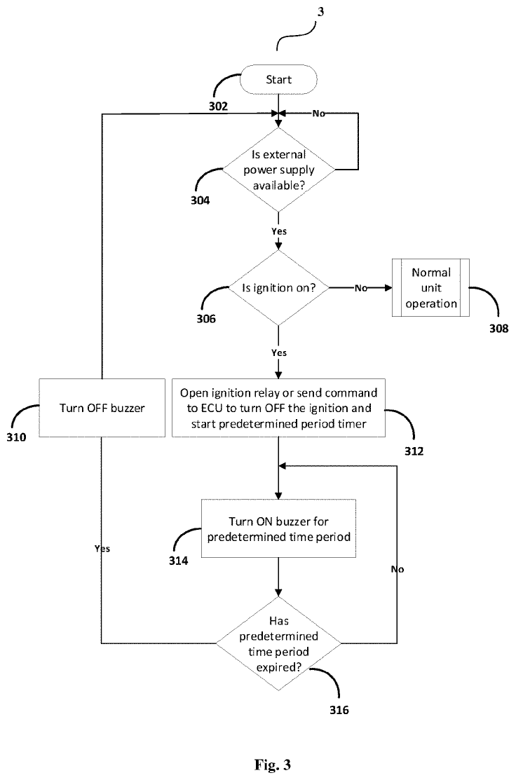

FIG. 3 depicts a flowchart outlining the features of the invention in an embodiment of the invention. The flowchart 3 describes a method being performed for enabling the invention. The method starts at 302 and at step 304, it is determined that external power supply 400 is available for the vehicle. The external power supply 400 may be AC mains supply and the like for operating the refrigerator 100 installed on the vehicle.

At step 306, it is determined whether the ignition (ignition switch) 200 of the vehicle is “ON”. The ignition of the vehicle is governed by ignition switch as described above. If the ignition is “OFF” the process moves to step 308 and a normal mode of operation is performed. In the normal mode of operation, the AC power supply continues to operate the refrigerator and charge the battery on the vehicle. If the ignition is “ON”, then the RMU 104 switches the ignition relay 106 to “open” and send a command to ECU 300 to turn the ignition to “OFF” at step 312. The method also starts a predetermined timer to activate a buzzer.

At 314, a buzzer is activated to alert the user or the driver of the vehicle to indicate that the ignition of the vehicle is “ON” and the vehicle is connected to the external power supply.

At 316, the method determines if the predetermined timer has expired. If the predetermined period timer is not expired, the process continues to operate the buzzer to alert the user.

If the predetermined timer has expired, the buzzer is turned OFF and ignition relay is closed at 310. The ignition relay may also be closed if the buzzer is stopped manually before the expiry of the predetermined time period.

The present invention is applicable to various fields such as, but not limited to, transportation industry, pharmaceutical industry, cosmetics industry, food industry and any such field that is well known in the art and where an item can be transported and/or utilized.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

We claim:

1. A system comprising:
a refrigerator installed on a vehicle;
a battery or a diesel generator that powers the refrigerator when the vehicle is in a driving state;
an electrical port that connects to an AC mains supply via an electrical cable to directly power the refrigerator when the vehicle is in a stationary state;
a refrigerator main controller unit (RMU) that controls the power delivered to the refrigerator in both stationary and driving states of the vehicle; and
a safety system restricting the vehicle from being driven when the electrical port is connected to the electrical cable and the refrigerator is powered by the AC mains supply.

2. The system of claim 1,
wherein the safety system comprises an ignition relay switchable between a “closed” and an “open” state, wherein the ignition relay connects an ignition switch of the vehicle to the electronic control unit (ECU) of the vehicle in the ‘closed’ state and disconnects the ignition switch from the ECU in the ‘open’ state, and
wherein the ignition switch of the vehicle is switchable to an “on” state to allow the ECU to drive the vehicle and an “off” state to restrict the ECU from driving the vehicle.

3. The system of claim 2, wherein the RMU detects whether the electrical port is connected to the electrical cable and the refrigerator is powered by the AC mains supply and detects whether the ignition switch of the vehicle is in the “on” state or in the “off” state.

4. The system of claim 3, wherein the RMU switches the ignition relay between the “open” and “closed” states based on the detections.

5. The system of claim 4, wherein the RMU switches the ignition relay to the “open” state when the ignition switch is in the “on” state and the refrigerator is powered by the AC mains supply.

6. The system of claim 4, wherein the RMU switches the ignition relay to the “closed” state when the ignition switch is in the “off” state and the refrigerator is powered by the AC Mains supply.

7. The system of claim 4, wherein the RMU switches the ignition relay to the “closed” state when the ignition switch is in the “on” state and the refrigerator is powered by the battery.

8. The system of claim 4, wherein the RMU switches the ignition relay to the “closed” state when the ignition switch is in the “off” state and the refrigerator is powered by the battery.

9. The system of claim 4, wherein the safety system comprises a buzzer, wherein RMU activates the buzzer to alert a driver when the refrigerator is powered directly from the AC Mains supply and the ignition switch is in the “on” state.

10. The system of claim 1, wherein the vehicle is a battery electric vehicle and the battery that powers the refrigerator system when the vehicle is in a driving state is the same battery that powers the vehicle.

11. A method comprising:
powering a refrigerator installed on a vehicle by a battery or diesel generator when the vehicle is in a driving state;
connecting the refrigerator to an AC mains supply via an electrical cable to directly power the refrigerator when the vehicle is in a stationary state;
controlling the power delivered to the refrigerator in both stationary and driving states of the vehicle by a refrigerator main controller unit (RMU); and
restricting the vehicle from being driven by a safety system when the electrical port is connected to the electrical cable and the refrigerator is powered directly from the AC mains supply.

12. The method of claim 11, wherein the safety system comprises an ignition relay switchable between a “closed” and an “open” state, wherein the ignition relay connects the ignition switch to the ECU in the ‘closed’ state and disconnects the ignition switch from the ECU in the ‘open’ state.

13. The method of claim 11, wherein the RMU detects if electrical port is connected to the electrical cable and the refrigerator is powered directly from the AC Mains supply and detects if ignition switch of the vehicle is in the “on” or in the “off” states.

14. The method of claim 13, wherein the RMU switches the ignition relay between the “open” and “closed” states based on the detections.

15. The method of claim 14, wherein the RMU switches the ignition relay to the “open” state when the ignition switch is in the “on” state and the refrigerator is powered directly from the AC Mains supply.

16. The method of claim 14, wherein the RMU switches the ignition relay to the “closed” state when the ignition switch is in the “off” state and the refrigerator is powered directly from the AC Mains supply.

17. The method of claim 14, wherein the RMU switches the ignition relay to the “closed” state when the ignition switch is in the “on” state and the refrigerator is powered by the battery.

18. The method of claim 14, wherein the RMU switches the ignition relay to the “closed” state when the ignition switch is in the “off” state and the refrigerator is powered by the battery.

19. The method of claim 14, wherein the safety system comprises a buzzer, wherein RMU activates the buzzer to alert a driver when the refrigerator is powered directly from the AC Mains supply and the ignition switch is in the “on” state.

20. The method of claim 11, wherein the vehicle is a battery electric vehicle and the battery that powers the refrigerator system when the vehicle is in a driving state is the same battery that powers the vehicle.
